(19) United States
(12) Patent Application Publication
(10) Pub. No.: US 2013/0326412 A1
(43) Pub. Date: Dec. 5, 2013

(54) SYSTEMS AND METHODS FOR DISPLAYING RELATIONSHIPS BETWEEN DATA ITEMS, INDIVIDUALS, AND DYNAMICALLY CALCULATED METRIC SCORES

(71) Applicant: Adam TREISER, Brunswick, NJ (US)

(72) Inventor: Adam TREISER, Brunswick, NJ (US)

(21) Appl. No.: 13/907,032

(22) Filed: May 31, 2013

Related U.S. Application Data
(60) Provisional application No. 61/654,662, filed on Jun. 1, 2012.

(51) Int. Cl. G06F 3/0482

(52) U.S. Cl. CPC G06F 3/0482
USPC 715/810

(57) ABSTRACT

The present disclosure generally relates to providing an interface for visualization of data. In accordance with one implementation, a computer-implemented method is provided that comprises displaying one or more metrics and detecting a selection of the one or more metrics. The method also includes displaying one or more objects representing persona groups and one or more corresponding gravity wells for each selected one of the one or more metrics. The displayed interface visually represents correlation between each of the one or more objects, each of the one or more objects representing one of a corresponding persona group from persona groups, and the corresponding gravity well.

### CROSS-REFERENCE TO RELATED APPLICATIONS

This application claims the benefit of priority to U.S. Provisional Application No. 61/654,662 filed on Jun. 1, 2012, the entire disclosure of which is expressly incorporated herein by reference in its entirety.

### BACKGROUND

1. Technical Field

The present disclosure generally relates to systems and methods for displaying relationship values utilizing data visualization tools. For example, and without limitation, providing high-end data visualization related to consumers. The underlying data to be visually presented may be harvested from the Internet, acquired from partner organizations or third party vendors, all of which can further be combined with a company's own information.

2. Background

Today, data analytics is utilized for various purposes in organizations. Data analytics may be helpful to corporations in analyzing previous performances and to make future projections, aiding in targeting specific subsets of individuals for certain products or making additional business decisions, such as producing certain products that cater to a particular clientele. Various techniques are currently utilized for organizing and presenting data, such as charts and figures. However, many of these approaches do not provide a visual contextual overview of the data and relationship values between consumers and certain metrics. Accordingly, there is a need for improved systems and methods for visually providing data related to relationship values.

### SUMMARY

Embodiments consistent with the present disclosure provide for an interface for visualization of data. Moreover, embodiments consistent with the present disclosure include computerized systems and methods for providing high-end data visualization tools regarding consumers.

In accordance with some embodiments, a computer-implemented method is disclosed for providing an interface for visualization of data. The method comprises displaying one or more metrics and detecting a selection of the one or more metrics. The method further includes displaying one or more objects representing persona groups and one or more corresponding gravity wells for each selected one of the one or more metrics, wherein the interface visually represents correlation between each of the one or more objects, each of the one or more objects representing one of a corresponding persona group from persona groups, and the corresponding gravity well.

In accordance with additional embodiments of the present disclosure, a system is disclosed for providing an interface for visualization of data. The system comprises at least one processor and a storage device that stores a set of instructions that, when executed by the at least one processor, causes the at least one processor to display one or more metrics and detect a selection of the one or more metrics. The set of instructions, when executed by the at least one processor, further causes the at least one processor to display one or more objects representing persona groups and one or more corresponding gravity wells for each selected one of the one or more metrics, wherein the interface visually represents correlation between each of the one or more objects, each of the one or more objects representing one of a corresponding persona group from persona groups, and the corresponding gravity well.

In accordance with still further embodiments of the present disclosure, a non-transitory computer-readable medium is provided for storing a set of instructions that, when executed by at least one processor, cause the at least one processor to display one or more metrics and detect a selection of the one or more metrics. The set of instructions, when executed by the at least one processor, further cause the at least one processor to display one or more objects representing persona groups and one or more corresponding gravity wells for each selected one of the one or more metrics, wherein the interface visually represents correlation between each of the one or more objects, each of the one or more objects representing one of a corresponding persona group from persona groups, and the corresponding gravity well.

### BRIEF DESCRIPTION OF THE DRAWINGS

The accompanying drawings, which are incorporated in and constitute a part of this specification, illustrate several embodiments of the present disclosure and, together with the description, serve to explain the principles and features of the present disclosure.

FIG. 1 is a flow chart of an exemplary method for providing an interface for visualization of data, consistent with embodiments of the present disclosure.

FIGS. 2-5 illustrate exemplary interfaces, consistent with embodiments of the present disclosure.

FIG. 6 illustrates an exemplary computer system, consistent with embodiments of the present disclosure.

### DETAILED DESCRIPTION OF EXEMPLARY EMBODIMENTS

Reference will now be made in detail to embodiments of the present disclosure, examples of which are illustrated in the accompanying drawings. The discussion will use the same reference numbers included in the drawings to refer to the same or like parts.

In this disclosure, the use of the singular includes the plural, unless specifically stated otherwise. Also, in this disclosure, the use of “or” means “and/or,” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

Embodiments of the present disclosure provide improved systems and methods for high-end data visualization of relationship values. Specifically, the present disclosures provides data visualization tools for effectively displaying relationship values, between one or more of metrics, persona groups, individuals, and products. The underlying concepts related to the calculation of relationship values are discussed at length in U.S. patent application Ser. No. 13/461,660, which is hereby incorporated by reference. The embodiments presented in the present disclosure are related to the visualization of the data.

In some embodiments, data items acquired to determine relationship values may include objective and quantitative data, as well as subjective and qualitative data. In an implementation, the relationship of an individual to a metric may be determined and characteristics describing individuals generally may be stored along with metrics relevant to an organization. Additional information may be utilized to determine a number of relationships between the data items, individuals, metrics, and characteristics. These relationships may be utilized to determine an overall relationship between the individual and the metric, based on the data and the characteristics. In addition, related groups of characteristics may be identified. Similarly, the relationships between any individual, metric, sub-metric, group of characteristics, data item, data source, characteristic, or groups thereof may also be determined.

Consistent with embodiments of the present disclosure, an interface comprising a metric dashboard may be displayed. The metric dashboard may display all or some of the possible metrics related to which a system contains data. At a selection of one of the metrics, one or more gravity wells corresponding to the metric may be displayed. Additionally, objects representing persona graphs corresponding to the selected metric may be displayed. The objects may be displayed as circles around the respective gravity wells. The opacity of the respective circle may represent a correlation between the metric associated with the corresponding gravity well and a corresponding persona group associated with the circle. Furthermore, the size of the circle may represent the size of the persona group. Accordingly, an interface may provide a high-end contextual visualization of relationship values between metrics and persona groups. More details regarding a persona group may be viewed in the form of a persona scorecard by selecting a persona group.

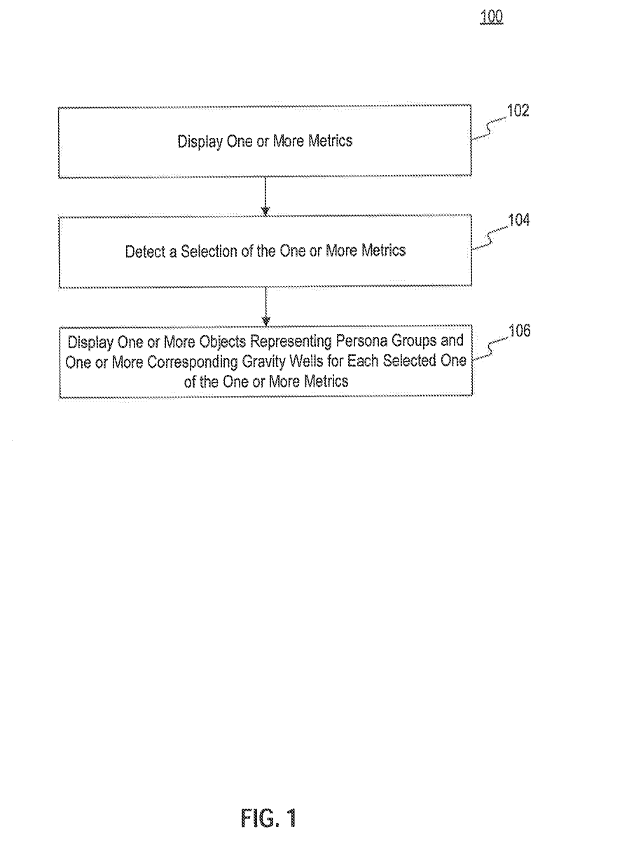

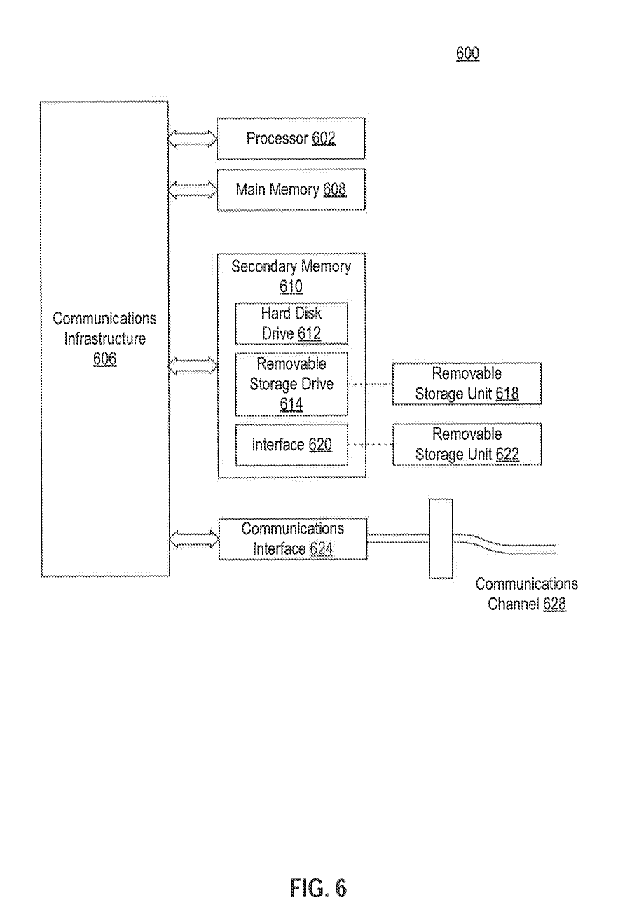

FIG. 1 is a flow chart of an exemplary method for providing an interface for visualization of data, consistent with embodiments of the present disclosure. The exemplary method may be processed based on instructions encoded on a computer-readable medium storage device, for example included within system 600 presented in FIG. 6. As one of ordinary skill in the art would comprehend, one or more processors of system 600 may be utilized.

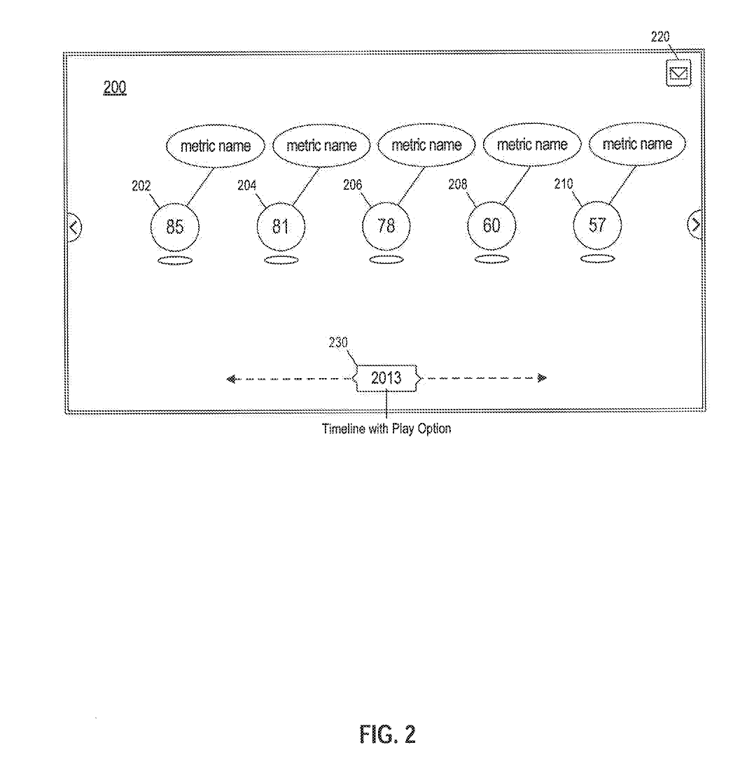

In step 102, a system may display one or more metrics. For example, FIG. 2 illustrates an exemplary interface 200 displaying a metric dashboard where metrics 202, 204, 206, 208, and 210 are illustrated. The concept of a metric is discussed at length in U.S. patent application Ser. No. 13/461,660, which is hereby incorporated by reference. A metric may, for example, represent any goal, attribute, measurement, strategy, or other information of interest.

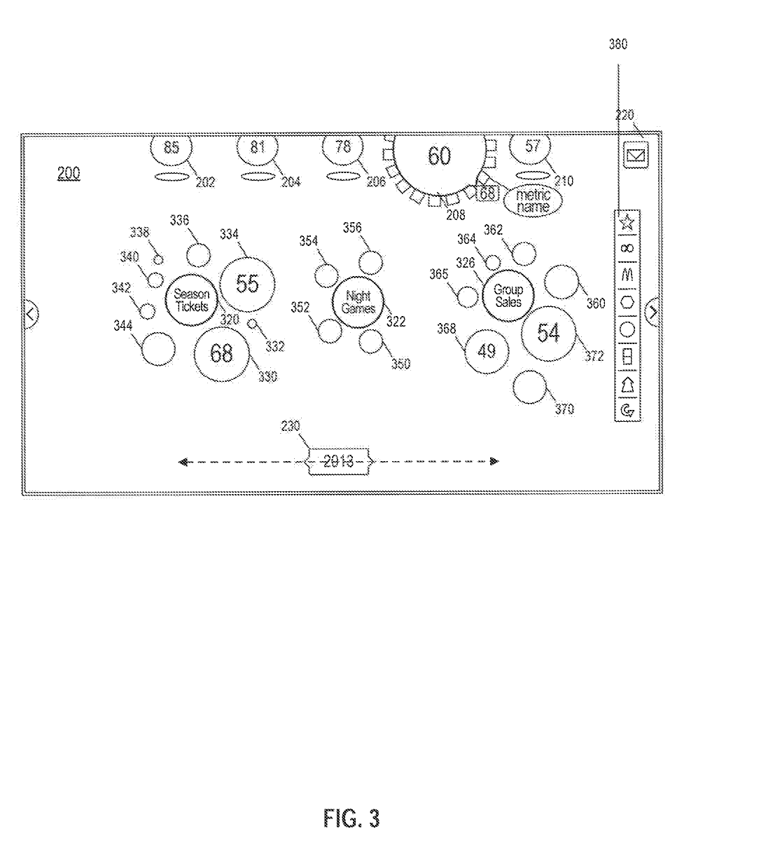

The metric dashboard may also include a button 220 that takes the user to a messaging system. The messaging system (not illustrated) may allow a user to communicate with recipients related to a display of interface 200. For example, at the metric dashboard, a user may message all recipients related to a particular metric. However, if persona groups are displayed on an interface, such as in FIG. 3, a user may message all recipients related to a metric, or alternatively one or more of particular persona groups.

The metric dashboard may also include a timeline 230 that allows the user to view one or more metric states at a given time in the past, present, or projected into the future. For example, toggling of the timeline 230 illustrates past data related to the metric or future projections related to the metric. This allows the user to watch how the metrics have evolved, or may evolve, over time. A movement towards the left of the timeline may represent a user desire to see past performance while toggling towards the right may indicate a user desire to see future projections. In an embodiment, future projections may be generated utilizing one of one or more types of analysis such as trending analysis, regression analysis, and correlation analysis, or through other analytical methods known in the art.

In some embodiments, a user may zoom in or out of timeline 230 (e.g., by pinching, as may be the case with certain mobile computing devices) to one day or zoom out to a number of years. For example, the past data and the future projections related to the metric may be within a timeframe of 5 years from a current date.

In other embodiments, displayed timeline 230 may be based upon certain triggering events that are different frames of references than a number of hours, days, weeks, months, or years. For example, a triggering event may be the achievement of certain objectives, where the furthest date in the future is the expected achievement date. Or, the timeline 230 represent a “countdown” regarding how much time has elapsed since the launch of a campaign and the deadline associated with the expected end of the campaign.

In exemplary embodiments, each displayed metric 202, 204, 206, 208, and 210 may be depicted utilizing a different color.

In step 104, the system may detect a selection of the one or more metrics. For example, a user selection may be a detection of a particular metric. The computing system 600 may detect that a user input has selected one of metrics 202, 204, 206, 208, and 210. The displayed selected metric may be enlarged based on a user selection. For example, metric 208 is enlarged compared to metrics 202, 204, 206, and 210 in FIG. 3.

In step 106, the system may display one or more objects representing persona groups and one or more corresponding gravity wells for each selected one of the one or more metrics, wherein the interface visually represents correlation between each of the one or more objects, each of the one or more objects representing one of a corresponding persona group from persona groups, and the corresponding gravity well.

For example, FIG. 3 illustrates interface 200 updated in response to selection of a metric. For example, based on a selection of metric 208. As discussed above, since metric 208 is the selected metric it is enlarged compared to the other respective metrics 202, 204, 206, and 208 on the metric dashboard.

In embodiments, metrics 202-210 displayed on top of interface 200 are the same metrics that are displayed in FIG. 2 utilizing the same colors with altered locations. However, in embodiments, the sizes of the displayed metrics may be altered based on, among other things, user choice, screen size, screen requirements, and metric selections.

In response to a selection of a metric in step 104, one or more objects representing persona groups and one or more corresponding gravity wells for each selected one of the one or more metrics may be displayed in step 106. Therefore, the interface visually may represent a correlation between each of the one or more objects, each of the one or more objects representing one of a corresponding persona group from persona groups, and the corresponding gravity well.

In embodiments, gravity wells allow a different way to organize persona groups that are correlated to the selected metric. For example, if a user would like to see how different communication platforms are related to the persona groups that have been highlighted, then a user may select the communication platform gravity well which may be an aspect of a particular metric. For the example, the three communication platform of interest may be email, Twitter, and Facebook. Accordingly, three gravity wells will appear and be labeled email, Twitter, and Facebook. The persona groups will be displayed in proximity of their associated gravity wells.

In embodiments, a default view of the display when a metric is first selected may be an arbitrary single gravity well in the center of the screen. However, additional gravity wells corresponding to the metric may be displayed based on, for example, user selection as explained in further detail below.

For example, FIG. 3 illustrates three exemplary gravity wells: Season Tickets 320, Night Games 322, and Group Sales 324. In embodiments, gravity wells may include any metric or parameter upon which a user wishes to determine the relevant persona groups. For example, they may include locations (e.g., a town or a football stadium), communications platforms (e.g., Twitter, Facebook, e-mail, etc.), religions, etc.

In FIG. 3, persona groups are represented by the circles surrounding each gravity well. These persona groups may be moved around their associated gravity wells. The size of the circle may represent the size of its persona group. The opacity of the circle may represent the amount of correlation that the persona group has to the selected metric. The shade, hue, or color of the circles may represent how similar each persona group is to other persona groups. Each persona group may also have a score, which may also show wow correlated that group is to the selected metric.

A gravity wells bar 380 is also illustrated. Utilizing icons included with the gravity wells bar 380, a user may choose to display only certain gravity wells of interest and the corresponding persona graphs. For example, if a user is only interested in Seasons Tickets 320 and the related persona groups, the user would be allowed to focus on those particular relationship values.

In embodiments, gravity wells may also include one or more orbital rings (not illustrated) around them for use as a unit of measurement. For example, the circles may be placed at different distances from the gravity well based on one or more relationships with the gravity well. The persona graph may include a series of rings at certain distances from the gravity will. Thus, the user may be able to use these rings as a unit by which to compare the relationships between the different persona groups and the gravity well.

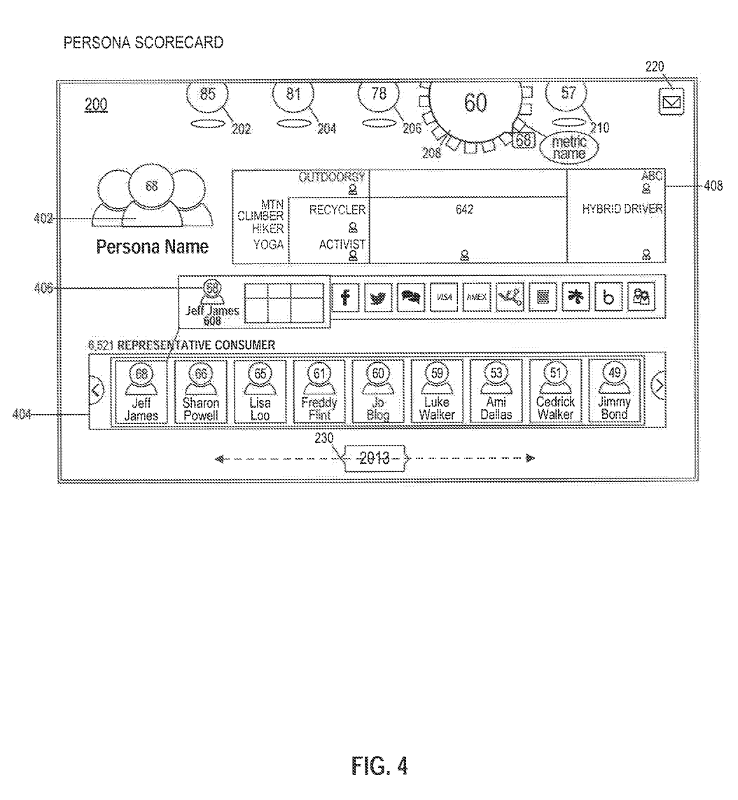

In additional embodiments of the present disclosure, responsive to determining a user selection of a persona group of the persona groups, instructions are generated to display a persona scorecard for the persona group. For example, FIG. 4 displays an exemplary persona scorecard 400. The persona scorecard depicts at least one or more customers associated with the persona.

The persona group icon 402 may be displayed in the head of the persona image. The persona group icon 402 may also include a persona name making it easier for a user to determine characteristics of that persona. A persona population breakdown 408 may be displayed as a collection of rectangles that depict one or more factors that correspond to the persona. In one embodiment, the size of each rectangle depicts the correlation of a factor represented by the rectangle relative to the other factors. The color of each factor may be based on the relevant metrics. In another embodiment, each rectangle may represent a characteristic group or a characteristic. Within that rectangle, a heat map may depict smaller rectangles that represent subsets within that characteristic group or characteristic. For example, a rectangle may be titled “Personality Traits.” The heat map may then display smaller rectangles representing the various personality traits considered. The heat may also serve to demonstrate how relevant each specific Personality Trait may be to a persona. In another embodiment, each rectangle may be a dynamic tile that, when selected, “flips” backwards to display the reverse side of such tile, which would contain additional detail regarding the information displayed by the tile.

In embodiments, a persona scorecard view may also depict one or more customers that are representative of the persona in consumer box 404. Additionally, in some embodiments one or more representative customers may specifically be highlighted in highlight boxes 406 providing additional details about that customer.

In embodiments, a user may also have the ability to adjust the weights for one or more of the factors, that is, impact that the factors has on a persona graph.

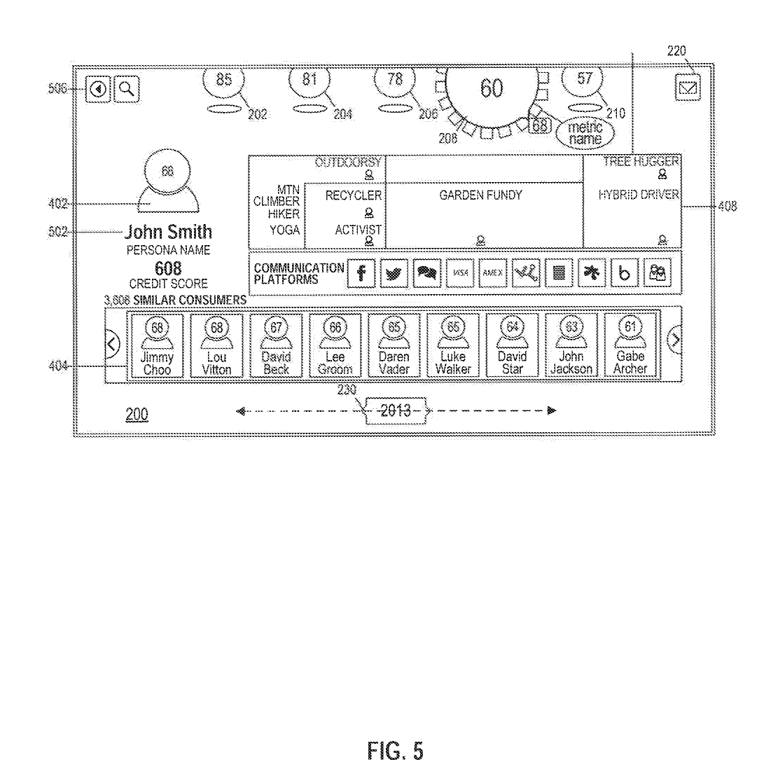

In embodiments, responsive to a selection of a particular individual from consumer box 404, instructions are generated to display a consumer scorecard for the particular individual. For example, FIG. 5 depicts an exemplary consumer scorecard within the persona scorecard view. This view displays a profile 502 for an individual consumer. For example, profile 502 includes a name and credit score of John Smith. Additional embodiments may include additional relevant information such as persona score or name, additional metrics or numerical values associated with a particular individual.

In additional embodiments, prior transaction history related to a consumer may be displayed. The transaction history may be comprehensive or limited to a specific timeframe. For example, to see prior purchase volume by month, a box may contain a calendar with a number of dollar signs (or a specific dollar number) and a trending signal, such as an arrow, color or size of the type-font, to depict how this transaction history compares to the customer's average spending volume. Additionally, images of past purchased products may be displayed. For example, the user may be able to scroll through these images, or each image may be displayed for a predetermined period of time. The same may be done using images that represent lifestyle indicators for the consumer. For example, images of mountain biking or surfing may be displayed. Further exemplary information on views and processes for FIG. 6 is in the attached appendix.

FIG. 5 also includes a back button 506. Selection of back button 506 leads to a return to the persona scorecard presented in the exemplary interface presented in FIG. 4.

In exemplary embodiments, toggling of the timeline button 230 may be utilized in interface 200 updating the displayed information for all the displayed aspects. For example, history related to a persona scorecard at various times in the past may be displayed. However, as one or ordinary skill in the art may comprehend, certain future projections about individual characteristics in a consumer card may currently not be made.

In additional embodiments, a user may be permitted to dial up or dial down the selected metric to a desired value. This will cause the other metrics, persona groups for the selected metric, or both to be updated, in order to show the resulting changes to each metric, persona group, or both necessary to achieve the dialed up or down metric value.

In an embodiment, a user may also be permitted to lock one or more of the other metrics. Therefore, the modifications to achieve the dialed up or down value for the selected metric will not allow the locked value of the other metric(s) to be effected. Each metric may also be given a particular “floor” value, which will not permit any action that would cause that metric to drop below such “floor” value, or each metric may be assigned a “change threshold”, which will not permit any action that would cause that metric to change by a certain amount or percentage.

FIG. 6 illustrates an exemplary computer system 600, consistent with embodiments of the present disclosure. As shown in FIG. 6, computer system 600 includes one or more processors, such as processor 602. Processor 602 is connected to a communications infrastructure 606, such as a bus or network.

Computer system 600 also includes a main memory 608, for example, a random access memory (RAM), and may include a secondary memory 610. Secondary memory 610 may include, for example, a hard disk drive 612 and/or a removable storage drive 614, representing a magnetic tape drive, an optical disk drive, CD/DVD drive, etc. Removable storage drive 614 reads from and/or writes to a removable storage unit 618 in a well-known manner. Removable storage unit 618 represents a magnetic tape, optical disk, or other non-transitory computer-readable storage medium that is read by and written to by removable storage drive 614. As will be appreciated, the removable storage unit 618 can represent a non-transitory computer-readable medium having stored therein computer programs, sets of instructions, code, or data to be executed by processor 602.

In alternate embodiments, secondary memory 610 may include other means for allowing computer programs or sets of instructions to be loaded into computer system 600. Such means may include, for example, a removable storage unit 622 and an interface 620. An example of such means may include a removable memory chip (e.g., EPROM, RAM, ROM, DRAM, EEPROM, flash memory devices, or other volatile or nonvolatile memory devices) and an associated socket, or other removable storage units 622 and interfaces 620, which allow instructions and data to be transferred from removable storage unit 622 to computer system 600.

Computer system 600 may also include one or more communications interfaces, such as communications interface 624. Communications interface 624 allows computer software, instructions, and/or data to be transferred between computer system 600 and external devices. Examples of communications interface 624 may include a modem, a network interface (e.g., an Ethernet card), a communications port, a PCMCIA slot and card, a wireless transmitter or card, etc. Computer software, instructions, and/or data may be transferred via communications interface 624 in the form of signals (not shown), which may be electronic, electromagnetic, optical, or other signals capable of being received by communications interface 624. These signals 626 are provided to communications interface 624 via a communications path (i.e., channel 628). Channel 628 carries signals 626 and may be implemented using wire or cable, fiber optics, an RF link, wireless transmissions, and other communications channels. In another embodiment, signals 626 comprise data packets sent to processor 602. Information representing processed packets can also be sent in the form of signals 626 from processor 602 through channel 628.

The terms “storage device” and “storage medium” may refer to particular devices including, but not limited to, main memory 608, secondary memory 610, a hard disk installed in hard disk drive 612, and removable storage units 618 and 622. Further, the term “non-transitory computer-readable medium” may refer to devices including, but not limited to, a hard disk installed in hard disk drive 612, any combination of main memory 608 and secondary memory 610, and removable storage units 618 and 622, which respectively provide computer programs and/or sets of instructions to processor 602 of computer system 600. Such computer programs and sets of instructions can be stored within one or more non-transitory computer-readable media. Additionally, or alternatively, computer programs and sets of instructions may also be received via communications interface 624 and stored on the one or more computer-readable media.

Such computer programs and instructions, when executed by processor 602, enable processor 602 to perform one or more of the computer-implemented methods described herein. Examples of program instructions include, for example, machine code, such as code produced by a compiler, and files containing a high-level code that can be executed by processor 602 using an interpreter.

The computer-implemented methods described herein can also be implemented on a single processor of a computer system, such as processor 602 of system 600. In another embodiment, computer-implemented methods consistent with embodiments of the present disclosure may be implemented using one or more processors within a single computer system, and additionally or alternatively, these computer-implemented methods may be implemented on one or more processors within separate computer systems linked via a network.

Various embodiments have been described herein with reference to the accompanying drawings. It will, however, be evident that various modifications and changes may be made thereto, and additional embodiments may be implemented, without departing from the scope of the present disclosure or the subject matter as set forth in the claims that follow.

Further, other embodiments will be apparent to those skilled in the art from consideration of the specification and practice of one or more embodiments disclosed herein. It is intended, therefore, that this disclosure and the embodiments herein be considered as exemplary only, with a true scope and spirit of the present disclosure being indicated by the following listing of exemplary claims.

What is claimed is:

1. A computer-implemented method for providing an interface for visualization of data, the method comprising:
displaying one or more metrics;
detecting a selection of the one or more metrics; and
displaying one or more objects representing persona groups and one or more corresponding gravity wells for each selected one of the one or more metrics;
wherein the interface visually represents correlation between each of the one or more objects, each of the one or more objects representing one of a corresponding persona group from persona groups, and the corresponding gravity well.

2. The computer implemented method of claim 1, wherein the gravity wells include locations, communication platforms, or religious or political affiliations.

3. The computer implemented method of claim 1, wherein:
each of the one or more objects is illustrated as a circle surrounding the corresponding gravity well.

4. The computer implemented method of claim 3, wherein:
opacity of the respective circle represents a correlation between the metric associated with the corresponding gravity well and a corresponding persona group associated with the circle.

5. The computer implemented method of claim 3, wherein:
characteristics of each of the persona groups are represented utilizing one of shade, hue, and color for a corresponding circle.

6. The computer implemented method of claim 1, further comprising
determining a user selection of a persona group of the persona groups; and
responsive to a determination that the persona group is selected, generating instructions to display a persona scorecard for the persona group.

7. The computer implemented method of claim 1, wherein the persona scorecard depicts at least one or more customers associated with the persona.

8. The computer implemented method of claim 1, further comprising:
displaying a timeline associated with the selected one of the one or more metrics, wherein toggling of the timeline illustrates past data related to the metric or future projections related to the metric.

9. The computer implemented method of claim 8, wherein the past data and the future projections related to the metric are within a timeframe of 5 years from a current date.

10. The computer implemented method of claim 8, wherein the future projections are generated utilizing one of trending analysis, regression analysis, and correlation analysis.

11. The computer implemented method of claim 1, wherein each of the displayed one or more metrics is depicted utilizing a different color.

12. A system for providing content stacks for electronic content, the system comprising:
at least one processor; and
a storage device that stores a set of instructions that, when executed by the at least one processor, causes the at least one processor to:
display one or more metrics;
detect a selection of the one or more metrics; and
display one or more objects representing persona groups and one or more corresponding gravity wells for each selected one of the one or more metrics;
wherein the interface visually represents correlation between each of the one or more objects, each of the one or more objects representing one of a corresponding persona group from persona groups, and the corresponding gravity well.

13. The system of claim 12, wherein the gravity wells include locations, communication platforms, or religious or political affiliations.

14. The system of claim 12, wherein:
each of the one or more objects is illustrated as a circle surrounding the corresponding gravity well.

15. The system of claim 14, wherein:
opacity of the respective circle represents a correlation between the metric associated with the corresponding gravity well and a corresponding persona group associated with the circle.

16. The system of claim 14, wherein:
characteristics of each of the persona groups are represented utilizing one of shade, hue, and color for a corresponding circle.

17. The system of claim 12, wherein the set of instructions further causes the at least one processor to:
determine a user selection of a persona group of the persona groups,
responsive to a determination that the persona group is selected, generate instructions to display a persona scorecard for the persona group.

18. The system of claim 12, wherein the persona scorecard depicts at least one or more customers associated with the persona.

19. The system of claim 12, wherein the set of instructions further causes the at least one processor to:
display a timeline associated with the selected one of the one or more metrics, wherein toggling of the timeline illustrates past data related to the metric or future projections related to the metric.

20. The system of claim 19, wherein the past data and the future projections related to the metric are within a timeframe of 5 years from a current date.

21. The system of claim 19, wherein the future projections are generated utilizing one of trending analysis, regression analysis, and correlation analysis.

22. The system of claim 12, wherein each of the displayed one or more metrics is depicted utilizing a different color.

23. A non-transitory computer-readable medium storing a set of instructions that, when executed by at least one processor, cause the at least one processor to:
display one or more metrics;
detect a selection of the one or more metrics; and
display one or more objects representing persona groups and one or more corresponding gravity wells for each selected one of the one or more metrics;
wherein the interface visually represents correlation between each of the one or more objects, each of the one or more objects representing one of a corresponding persona group from persona groups, and the corresponding gravity well.

24. The non-transitory computer-readable medium of claim 23, wherein the gravity wells include locations, communication platforms, or religious or political affiliations.

25. The non-transitory computer-readable medium of claim 23, wherein:
each of the one or more objects is illustrated as a circle surrounding the corresponding gravity well.

26. The non-transitory computer-readable medium of claim 25, wherein:
opacity of the respective circle represents a correlation between the metric associated with the corresponding gravity well and a corresponding persona group associated with the circle.

27. The non-transitory computer-readable medium of claim 25, wherein:
characteristics of each of the persona groups are represented utilizing one of shade, hue, and color for a corresponding circle.

28. The non-transitory computer-readable medium of claim 23, wherein the set of instructions further causes the at least one processor to:
determine a user selection of a persona group of the persona groups; and
responsive to a determination that the persona group is selected, generate instructions to display a persona scorecard for the persona group.

29. The non-transitory computer-readable medium of claim 23, wherein the persona scorecard depicts at least one or more customers associated with the persona.

30. The non-transitory computer-readable medium of claim 23, wherein the set of instructions further causes the at least one processor to:
display a timeline associated with the selected one of the one or more metrics, wherein toggling of the timeline illustrates past data related to the metric or future projections related to the metric.

31. The non-transitory computer-readable medium claim 30, wherein the past data and the future projections related to the metric are within a timeframe of 5 years from a current date.

32. The non-transitory computer-readable medium of claim 30, wherein the future projections are generated utilizing one of trending analysis, regression analysis, and correlation analysis.

33. The non-transitory computer-readable medium of claim 23, wherein each of the displayed one or more metrics is depicted utilizing a different color.
